(19) United States
(12) Patent Application Publication
(10) Pub. No.: US 2006/0222811 A1
(43) Pub. Date: Oct. 5, 2006

(54) Process for producing continuous fiber reinforced thermoplastic composites

(76) Inventors: Jeffrey K. Greason, Tehachapi, CA (US); Daniel L. DeLong, Mojave, CA (US); Douglas B. Jones, Mojave, CA (US)

Correspondence Address: CHRISTIE, PARKER & HALE, LLP, PO BOX 7068, PASADENA, CA, 91109-7068, US

(21) Appl. No.: 11/388,862

(22) Filed: Mar. 24, 2006

Related U.S. Application Data
(60) Provisional application No. 60/667,346, filed on Mar. 31, 2005.

(51) Int. Cl. B32B 5/12

(52) U.S. Cl. 428/110

(57) ABSTRACT

A method and system for reinforcing a fluoropolymer with continuous fibers are provided. The method comprises pulling a tow of fiber through a dispersion bath to impregnate the tow fibers with a fluoropolymer. The method further comprises drying the impregnated tow, followed by baking off any surfactant residue. The method further comprises consolidating the impregnated particles into the exterior and interior voids of the tow fibers.

### CROSS-REFERENCE TO RELATED APPLICATION(S)

This application claims the benefit of U.S. Provisional Application No. 60/667,346, and entitled “PROCESS FOR CONTINUOUS FIBER REINFORCED FLUOROPOLYMER COMPOSITES,” filed on Mar. 31, 2005, the content of which is incorporated herein by reference.

### FIELD OF THE INVENTION

The present invention is directed to a process for continuously producing fiber reinforced fluoropolymer composites.

### BACKGROUND OF INVENTION

Fluoropolymers are polymers in which some or all of the hydrogen atoms in hydrocarbons are replaced with fluorine. These include, without limitation, PTFE, FEP and PFA, PCTFE, PVDF, PFA, and specialty copolymers combining these polymers in various proportions. These are sold under trade names such as Teflon™, Chemfluor™, Kynar™, Aclar™, Clarus™, Kel-F™, and Neoflon™ by various manufacturers.

Fluoropolymers have a number of desirable properties, such as chemical resistance, oxidation resistance, flexibility at cryogenic temperatures, and low gas permeability. For these applications, particularly in cryogenic tanks, but also in other applications exploiting the unique properties of fluoropolymers, such as chemically resistant tanks for nitrous oxide or hydrogen peroxide, and high temperature thermoplastic structures for general aerospace structures.

Fluoropolymers sold commercially are often reinforced with ceramic particles or short chopped fibers of glass or carbon to improve their strength or tribological properties. These composite materials can be divided into two main categories normally referred to as short fiber reinforced materials and continuous fiber reinforced materials. Continuous reinforced materials will often constitute a layered or laminated structure. Reinforcement with long, layered or laminated continuous fibers will provide superior strength, as well as offer a lower thermal expansion coefficient than particle or short fiber reinforcement.

However, the conventional processes used in making continuous fiber reinforced plastic composites with plastics such as epoxy and phenolic do not work with fluoropolymers. Epoxy is a thermoset plastic, which can be applied as a low viscosity liquid, thoroughly wetting the fibers, before the polymerization reaction is completed in a curing process. Fluoropolymers are thermoplastic materials—they come from the vendor already polymerized and are softened by heating to process the materials. Other thermoplastic materials such as polyethylene, polystyrenes, polypropylene, etc., are made into composites. In this case, the thermoplastic materials can be heated to a temperature where they will flow freely, allowing them to wet the fibers and form a composite. Similarly, reinforced reaction injection molded polymers, such as polyurethanes, are low viscosity during injection and react in the mold to form the matrix chemistry.

All of the fluoropolymers listed above are characterized by very high viscosity in the molten state—indeed, the viscosity may be so high that they practically resemble a solid well above the melting point. All these fluoropolymers have a maximum processing temperature limited by the thermal decomposition of the fluoropolymer. Therefore, the viscosity cannot be made arbitrarily low by raising the temperature far above the melting point.

A typical technique for fabrication of continuous fiber reinforced fluoropolymers includes a technique used for specialty printed circuit board materials from PTFE, and dispersion processed architectural materials. In the case of printed circuit board, fluorocarbon particles are impregnated typically, with heat and high pressure. In the case of architectural cloth, a dispersion process along with some heat treatment impregnate fluorocarbon particles between the fibers in a cloth. Layers of cloth are then stacked and bonded in a heated press. However, these techniques are poorly suited for fabrication of more complex parts due to the difficulty of applying uniform high pressures to curved components such as a tank.

Furthermore, these standard processes involve taking the impregnated fibers and exposing them to heat in a batch process for a long period of time. Such batch processing would be prohibitively expensive for the production of pre-impregnated tow due to its low production rate. Therefore, a need exists for an improved process, which is capable of continuously producing continuous fiber reinforced fluoropolymer composites.

### SUMMARY OF THE INVENTION

In one embodiment, the present invention is a method for reinforcing a fluoropolymer with continuous fibers. The method includes: impregnating a tow of fiber by moving the tow through a dispersion bath; drying the tow; baking the tow; and consolidating the impregnated fluoropolymer particles into the interior and exterior voids of the tow fibers.

In one embodiment, the present invention is a method for reinforcing a fluoropolymer with continuous fibers. The method includes: impregnating a tow of fiber by moving the tow through a co-extruder, and consolidating the impregnated tow by moving it through a consolidation element.

### BRIEF DESCRIPTION OF THE DRAWINGS

FIG. 1 is a block diagram of a system for reinforcing a fluoropolymer with continuous fibers, according to one embodiment of the invention;

FIG. 2 is a flow diagram of a method for reinforcing a fluoropolymer with continuous fibers, according to one embodiment of the invention;

FIG. 3 is a block diagram of a system for reinforcing a fluoropolymer with continuous fibers, according to one embodiment of the invention;

FIG. 4 is a flow diagram of a method for reinforcing a fluoropolymer with continuous fibers, according to one embodiment of the invention; and

FIG. 5 is a schematic of a co-extruder used to impregnate a tow in a process for continuously reinforcing a fluoropolymer with continuous fibers, according to one embodiment of the invention.

### DETAILED DESCRIPTION

The present invention relates to the continuous fabrication of fiber reinforced fluoropolymer composites, particularly the preparation of pre-impregnated cloth or fiber tows for later processing into composite parts. Although the present invention has been described in the context of a process for continuously reinforcing a fluoropolymer with continuous fibers, one skilled in the art would appreciate that the present invention can be used with any thermoplastic or other material capable of being melted.

Conventional techniques for processing thermoplastics involve flowing the molten thermoplastic around the fibers, or a coarse mixing of the resin and the fibers (by weaving a fabric mixing plastic and ceramic fibers), which flows during processing. These techniques do not work with fluoropolymers because their viscosity is so high that they are highly resistant to flow.

There are three basic fabrication processes for turning fluoropolymer resins into components: injection molding, pressing granules together and sintering them, and dispersion processes in which fine dispersions of particles in a carrier liquid (such as water) are coated onto a surface, dried, and sintered together.

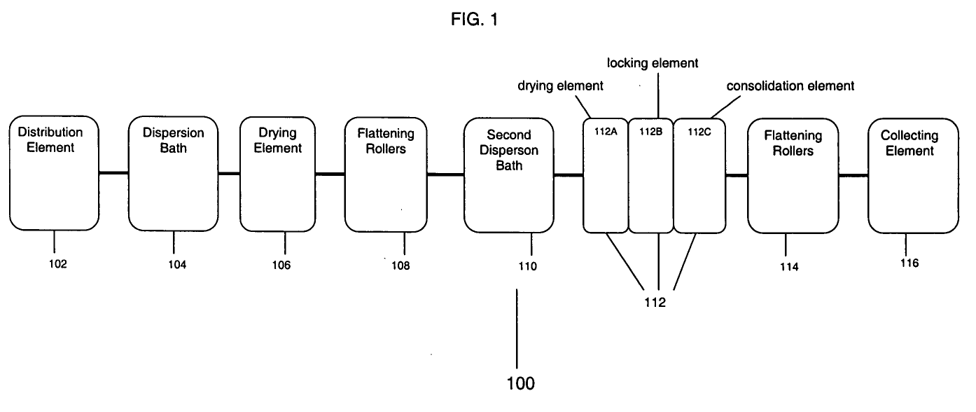

The present invention relates to a method and system for reinforcing a fluoropolymer with continuous fibers, for example FEP and PFA. FIG. 1 is an exemplary block diagram of a system 100 for reinforcing a fluoropolymer with continuous fibers. In one embodiment, the system 100 includes a distribution element 102; one or more dispersion baths 104, 110; one or more drying elements 106, 112A; one or more flattening rollers 108 (and 114); a baking element 112B; a consolidation element 112C; and a collecting element 116.

The composites produced from the present method can be used in production of many parts, such as cryogenic tanks. A cryogenic tank and method for forming such tanks are described in a co-pending U.S. patent application, Ser. No. 10/866,368, filed on Jun. 11, 2004, and entitled “Tanks For Cryogenic Fluids, Vehicles Incorporating Such Tanks And Methods For Forming Such Tanks,” the entire contents of which is hereby incorporated by reference.

The distribution element 102 is commonly a spool, which contains a tow of specified length wrapped around it. However, any mechanism capable of storing and distributing a tow can be used. A tow is defined as unwetted, untwisted, fibers gathered into a bundle. The dispersion bath 104 includes a roller system which aligns, and guides the tow through the bath. The dispersion bath 104 further includes a dispersion solution, which the tow is exposed to, while it is being moved through the dispersion bath 104.

The dispersion solution comprises a carrier fluid, for example water. The dispersion solution further comprises micron-sized particles of the material to be impregnated onto the tow, for example a fluoropolymer material. The dispersion solution further comprises a surfactant to keep the micron-sized particles suspended in the carrier fluid. The surfactant is commonly a detergent-type material, but any material, which sufficiently suspends the micron-sized particles in the carrier fluid can be used. Given the evaporation rate of water, the humidity of the environment surrounding the dispersion bath 104 needs to be kept high enough to minimize evaporation of the carrier fluid. In one embodiment, the humidity is kept as close to 100% as possible. Otherwise, the carrier fluid will evaporate and the micron-sized particles will come out of suspension prematurely.

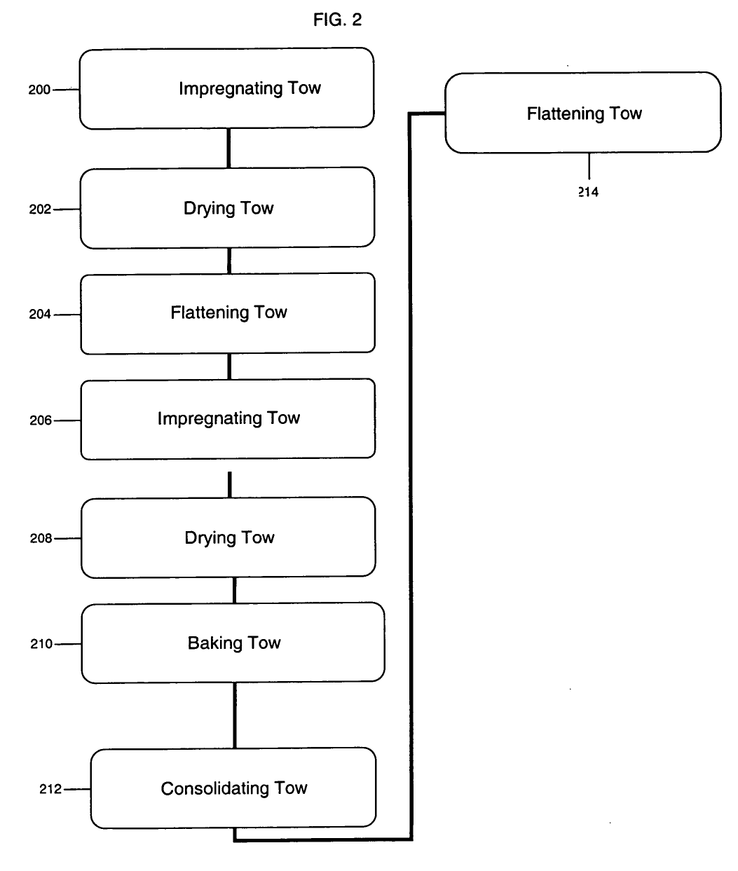

FIG. 2 is a flow diagram of a method for reinforcing a fluoropolymer with continuous fibers. To impregnate a tow of fiber with a fluoropolymer, the tow is first removed from a distribution element 102 and moved into a dispersion bath 104, in block 200.

While the tow is exposed to the dispersion solution, the micron-sized particles suspended in the carrier fluid are dispersed into the exterior and interior voids of the tow fibers. This process is defined as impregnation. Once the tow has been moved through the dispersion bath 104, it is next moved through a drying element 106, in block 202. In one embodiment, the drying element 106 is operated between the temperatures of approximately 120° and 140° C. In one embodiment, the drying element 106 is an oven, which uses a heat gun as its heat source. However, the drying element 106 can be any heating mechanism that is capable of heating the tow fibers to a temperature above 100° C.

In one embodiment, after the tow has been moved through the drying element 106, it may optionally be moved through one or more flattening rollers 108, as shown in block 204. The number of flattening rollers 108 used is dependent on the type of material used and the exact parameters required to produce a composite from that material. Depending on the material used, the amount of thermal deformation can vary, and with that variance, the number and type of flattening rollers 108 needed will vary. The flattening rollers 108 should be made of a material that does not scrape off the desired dispersion from the tow fibers. A material that is commonly used is polyethylene or the like. However, any low surface energy plastic can be used. Furthermore, one skilled in the art would appreciate that the flattening rollers 108 can be placed anywhere in the system 100 necessary to ensure that the tow maintains a flat, proportional profile.

In one embodiment, after the tow has been moved through the flattening rollers 108, it may optionally be moved through a second dispersion bath 110, as shown in step 206. In block 208, the tow may optionally then be moved through a second drying element 112A. After the tow is moved through the second drying element 112A it may optionally be moved through one or more flattening rollers 108. It should be noted that the tow may be moved through one or more dispersion baths 104, one or more drying elements 106 and one or more flattening rollers 108 as needed to impregnate the tow with the amount of fluoropolymer desired.

As the tow is moved through a dispersion bath, the amount of fluoropolymer particles that can impregnate the tow in that single dispersion step is limited. Therefore, in order to achieve the desired impregnation, the tow may need to be immersed in multiple dispersion baths. During each additional immersion into the dispersion bath, the tow becomes increasingly impregnated until the desired resin content is achieved. Once the tow has been consolidated, the consolidated fluoropolymer repels the carrier fluid, which makes further attempts to impregnate the tow in a dispersion bath futile.

In block 206, after the specified amount of fluoropolymer has been impregnated into the tow, the tow is then moved through a final heating apparatus 112. In one embodiment, the heating apparatus 112 includes three elements: a drying element 112A; a baking element 112B; and a consolidation element 112C. It should be noted that if the tow is being moved through the drying element 112A included in the heating apparatus 112, the tow does not have to be moved through flattening rollers until it has been moved through the heating apparatus 112. However, at the discretion of the user, one or more flattening rollers may be placed inside the heating apparatus at various locations.

In one embodiment, all the above-mentioned three elements are arranged in a single zone of a furnace. In one embodiment, the heating apparatus 112 can comprise one furnace with multiple zones for each separate element. In one embodiment, the drying element, the baking element, and the consolidation element comprise separate apparatuses, where the tow is moved in-and-out of each element individually.

After the tow is moved through the final drying element 112A, it is moved through the baking element 112B, as so depicted in block 210. While in the baking element 112B, the surfactant residue from the carrier fluid is baked off of the tow. In one embodiment, the baking element 112B is operated between the temperatures of approximately 220° and 250° C. In one embodiment, the baking element 112B comprises a stage in a temperature gradient of a one zone furnace. In one embodiment, the baking element 112B comprises a specific zone in a multi-zone furnace. In one embodiment, the baking element 112B comprises a separate, individual apparatus capable of reaching temperatures of at least 220° C.

The tow is then moved through a consolidation element 112C, in block 212. While in the consolidation element 112C, the impregnated fluoropolymer particles are sintered together and forced into the interior and exterior voids of the tow fibers. This process is defined as consolidation. In one embodiment, the consolidation element 112C is operated at temperatures of between approximately 320° and 330° C. In one embodiment, the consolidation element 112C comprises a stage in a temperature gradient of a one zone furnace. In one embodiment, the consolidation element 112C comprises a specific zone in a multi-zone furnace. In one embodiment, the consolidation element 112C comprises a separate, individual apparatus capable of reaching temperatures of at least 320° C.

In one embodiment, after the tow is moved 212 through the consolidation element 112C, it is moved through flattening rollers 114, as illustrated in block 214. Given the high temperature of the tow after exiting the consolidation element 112C, the flattening rollers 114 need to be made of a material capable of withstanding temperatures of at least 330° without sticking to the tow, such as virgin PTFE.

After the tow is moved 214 through the flattening rollers 114, it is gathered by a collecting element 116. The collecting element 116 includes a means for removing the tow from the distribution element 102 and moving the tow through: the one or more dispersion bath 104, 110; the one or more drying element 106, 112A; the baking element 112B; the consolidation element 112C; and the one or more flattening rollers 108, 114.

In one embodiment, the collecting element 116 is a spool where the consolidated tow is gathered to be stored for later use. In one embodiment, the collecting element 116 is a mandrel shaped like a part, for example a tank. If a mandrel is used as a collecting element, the already heated composite is gathered onto the mandrel and allowed to cool to form the intended part. In one embodiment, the mandrel may be pre-heated, for example in a hot air environment such as a convection oven, before the composite is gathered onto it.

It should be noted that the tow is continuously moved through the one or more dispersion bath 104, 110, the one or more drying element 106, 112A, the one or more flattening rollers 108, 114, the baking element 112B, and the consolidation element 112C at a specified speed, for example, one inch per second. However, the speed may be varied depending on the type of fluoropolymer used and the desired amount of fluoropolymer to be consolidated into the interior and exterior voids of the tow fibers.

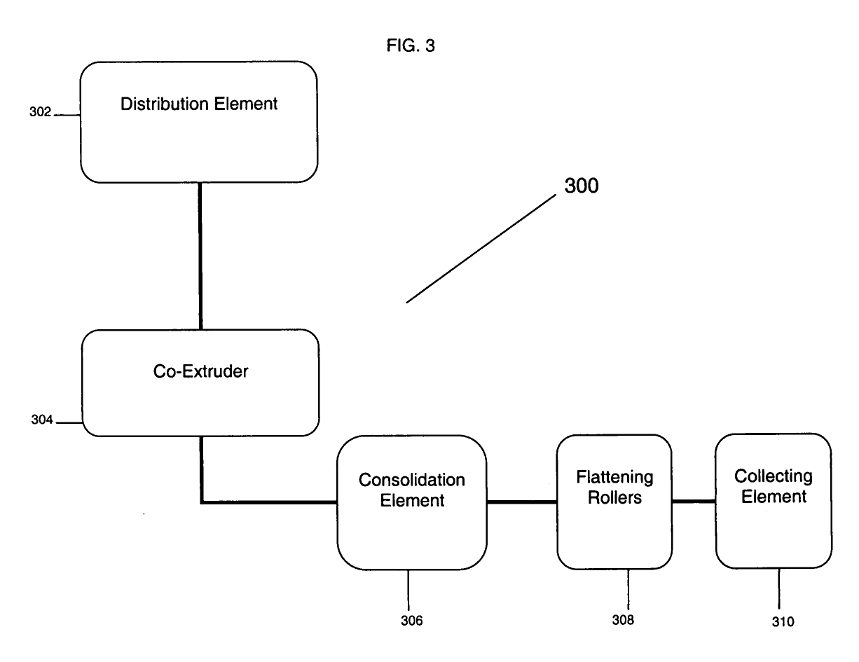

FIG. 3 is a block diagram of a system 300 for reinforcing a fluoropolymer with continuous fibers. In one embodiment, the system 300 includes a distribution element 302; a co-extruder 304; a consolidation element 306; and a collecting element 308.

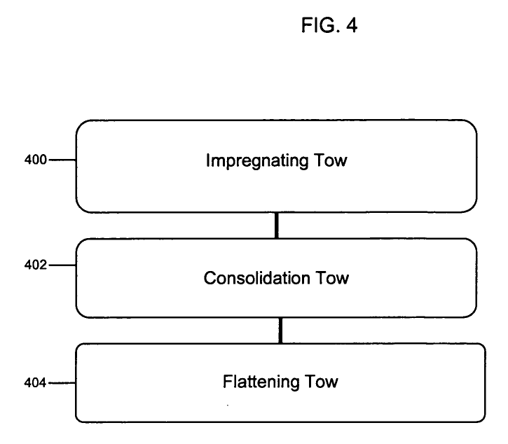

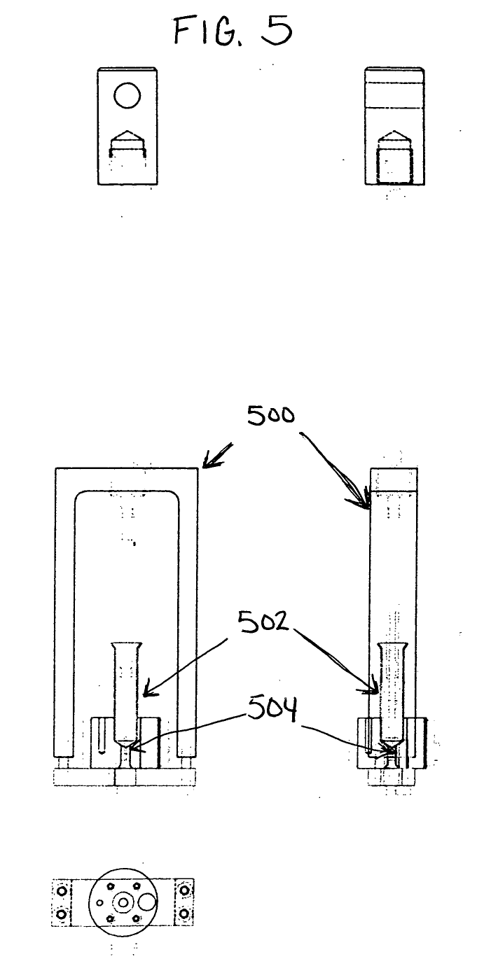

FIG. 4 is a flow diagram of a method for reinforcing a fluoropolymer with continuous fibers. FIG. 5 is a schematic of a co-extruder used to impregnate a tow in a process for reinforcing a fluoropolymer with continuous fibers, according to one embodiment of the invention.

In one embodiment, the tow is impregnated with a fluoropolymer by a co-extruder 304, as shown in block 400. The tow is continuously removed from a distribution element 302 and moved through a co-extruder 304, 500, in block 402. While the tow is moved through the co-extruder 304, 500, the fluoropolymer, in the form of a bar or a collection of granules, is driven by mechanical pressure into a heated zone, through a nozzle 502, and out an orifice 504 in a manner similar to injection molding. As long as the opening for the tow is in the cold zone, the fluoropolymer material does not flow out of the port where the tow enters the co-extruder. The tow is threaded through an exit orifice 504 before the fluoropolymer is loaded into the injection cavity. The fluoropolymer is then continuously moved through the co-extruder 304, 500 while heat and pressure are applied.

This drives intimate mixing of the fluoropolymer and fiber in three ways: the fiber is exposed to hot fluoropolymer under high mechanical pressure. Any cavities not filled by fluoropolymer see a high pressure gradient between the inside and outside of the exit orifice, driving fluoropolymer into the cavities. Finally, the converging section of the nozzle allows the designer or operator to set a velocity gradient. This is because the fluoropolymer flow velocity at the small diameter exit is higher than that at the large diameter entrance.

In one embodiment, the nozzle 502 may contain multiple converging and diverging sections to enhance this mixing effect. The tow, being moved from external force, moves at a constant velocity. This mismatch in velocity between the diverging and converging sections of the nozzle result in high shear forces within the viscous resin, forcing it to flow.

In one embodiment, in block 402, the tow is then moved through a consolidation element 306 where the impregnated tow is further consolidated. In one embodiment, the temperature of the consolidation element 306 is between approximately 320° and 330° C. In one embodiment, flattening rollers 308 are placed where necessary in order to avoid thermal deformation of the tow. After the tow has been moved through the consolidation element and any additional flattening rollers, it is then gathered by a collecting element 310.

The preceding merely illustrates the principles of the present invention. It will thus be appreciated that those skilled in the art will be able to devise various arrangements which, although not explicitly described or shown herein, embody the principles of the invention and are included within the scope and spirit. Furthermore, all examples and conditional language recited herein are principally intended expressly to be only for pedagogical purposes and to aid in understanding the principles of the invention and the concepts contributed by the inventors to furthering the art, and are to be construed as being without limitation to such specifically recited examples and conditions.

Moreover, all statements herein reciting principles, aspects, and embodiments of the invention, as well as specific examples thereof, are intended to encompass both structural and the functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein, but rather is intended to cover any changes, adaptations or modifications that are within the scope of the invention, as defined by the appended claims.

What is claimed is:

1. A method for reinforcing a thermoplastic material with continuous fibers, the method comprising:
moving a tow of fiber through a dispersion bath to impregnate the tow fibers with a thermoplastic;
drying the impregnated tow;
baking the dried impregnated tow; and
consolidating the baked impregnated tow, wherein the tow is continuously moved as it is being impregnated, dried, baked and consolidated.

2. The method of claim 1, wherein the thermoplastic is a fluoropolymer.

3. The method of claim 1, further comprising moving the tow through a second dispersion bath, and re-drying the tow.

4. The method of claim 1, further comprising removing the tow from a distribution element before it is moved through the dispersion bath.

5. The method of claim 1, wherein the dispersion bath comprises a dispersion solution.

6. The method of claim 5, wherein the dispersion solution comprises a carrier fluid.

7. The method of claim 5, wherein the dispersion solution comprises a surfactant.

8. The method of claim 5, wherein the dispersion solution comprises particles of the thermoplastic material.

9. The method of claim 1, further comprising moving the tow through one or more flattening rollers.

10. The method of claim 1, further comprising gathering the tow onto a collecting element after it is consolidated.

11. The method of claim 10, wherein the collecting element is a spool.

12. The method of claim 10, wherein the collecting element is a mandrel.

13. A system for reinforcing a thermoplastic material with continuous fibers, comprising:
a dispersion bath for impregnating a tow of fiber with a thermoplastic;
a drying element for drying the impregnated tow;
a baking element for baking the dried impregnated tow;
a consolidation element for sintering thermoplastic particles together and forcing them into interior and exterior voids of the tow fibers; and
a collecting element for continuously moving the tow through the dispersion bath, the drying element, the baking element, and the consolidation element, as the tow is being impregnated, dried, baked and consolidated.

14. The system of claim 13, wherein the environment surrounding the dispersion bath has a humidity of approximately 100%.

15. The system of claim 13, wherein the drying element is operated between the temperatures of approximately 120° and 140° C.

16. The system of claim 13, wherein the baking element is operated between the temperatures of approximately 220° and 250° C.

17. The system of claim 13, wherein the consolidation element is operated between the temperatures of approximately 320° and 330° C.

18. The system of claim 13, wherein the drying element, baking element, and consolidation element are located in one zone of a furnace.

19. The system of claim 13, wherein the drying element, baking element, and consolidation element are located in separate zones of a single furnace.

20. The system of claim 13, wherein the drying element is a separate heating apparatus.

21. The system of claim 13, wherein the baking element is a separate heating apparatus.

22. The system of claim 13, wherein the consolidation element is a separate heating apparatus.

23. A method for reinforcing a thermoplastic material with continuous fibers, the method comprising:
moving a tow through a co-extruder to impregnate the tow fibers with a thermoplastic; and
consolidating the impregnated tow by moving it through a consolidation element, where the tow is continuously moved as it is passing through the co-extruder and the consolidation element.

24. The method of claim 23, further comprising moving the tow through one or more flattening rollers.

25. The method of claim 23, further comprising removing the tow from a distribution element before it is moved through that co-extruder.

26. The method of claim 23, further comprising gathering the tow onto a collecting element after it is consolidated.

27. The method of claim 26, wherein the collecting element is a spool.

28. The method of claim 26, wherein the collecting element is a mandrel.

29. A system for reinforcing a thermoplastic material with continuous fibers, comprising:
a co-extruder for wetting and impregnating a tow of fiber with a thermoplastic;
a consolidation element for sintering the impregnated thermoplastic particles together and forcing them into interior and exterior voids of the tow fibers; and
a collection element for continuously moving the tow through the co-extruder and the consolidation element.

30. The system of claim 29, wherein the tow enters the co-extruder in a cold zone.

31. The system of claim 29, wherein the co-extruder has a nozzle.
